(19) United States
(12) Patent Application Publication
(10) Pub. No.: US 2026/0131549 A1
(43) Pub. Date: May 14, 2026

(54) FABRICATING METHOD FOR HYDROGEN STORAGE APPARATUS HAVING LIGHT WEIGHT COMPOSITE MATERIAL AND METHOD FOR INTERGRATED MANAGEMENT OF LIFE PREDICTION

(71) Applicant: AJOU UNIVERSITY INDUSTRY-ACADEMIC COOPERATION FOUNDATION, Gyeonggi-do (KR)

(72) Inventors: BONG SIK OH, Gyeonggi-do (KR); SANG CHUL PARK, Gyeonggi-do (KR)

(21) Appl. No.: 19/375,723

(22) Filed: Oct. 31, 2025

(30) Foreign Application Priority Data
Nov. 13, 2024 (KR) 10-2024-0161119

(51) Int. Cl. B29D 22/00; B29K 77/00; B29K 105/16; B29K 307/04; B29K 309/08; B29K 509/00

(52) U.S. Cl. CPC B29D 22/003; B29K 2077/00; B29K 2105/162; B29K 2307/04; B29K 2309/08; B29K 2509/00

(57) ABSTRACT

A method for fabricating a lightweight hydrogen storage apparatus includes producing a polyamide-nanoclay liner material by separately compounding polyamide with nanoclay and rubber with nanoclay to form masterbatches, co-extruding the masterbatches to obtain the liner composite, forming a liner by three-dimensional suction blow molding, spin-welding a boss to the liner to create an assembly, and filament-winding carbon and/or glass fibers over the assembly. The resulting vessel provides reduced mass and enhanced hydrogen permeation resistance suitable for small-diameter, high-pressure tanks used in electric vehicles. The life-prediction management method extracts signals from test-bed operation, selects degradation-indicative factors, evaluates condition to estimate service life on a server, and validates predictions using field data from deployed systems.

### CROSS-REFERENCE TO RELATED APPLICATION AND CLAIM OF PRIORITY

This application claims the benefit under 35 USC § 119 of Korean Patent Application No. 10-2024-0161119 filed on Nov. 13, 2024, in the Korean Intellectual Property Office, the entire disclosure of which is incorporated herein by reference for all purposes.

### BACKGROUND

### 1. Technical Field

The examples of the present invention relate to a fabricating method for a hydrogen storage apparatus having a light weight composite material and a method for integrated management of life prediction, and relate to a fabricating method for a hydrogen storage apparatus having a light weight composite material and a method for integrated management of life prediction which are suitable for small-diameter hydrogen storage tanks for common electric vehicle platforms.

### 2. Background Art

In response to recent global declarations and initiatives for carbon neutrality, the development of new hydrogen electric vehicles has been increasing by domestic and foreign automobile manufacturers, thereby requiring the establishment of efficient and safe hydrogen storage technologies.

A hydrogen tank, which is a core component of a hydrogen supply system in hydrogen electric vehicles, must store hydrogen gas under compression at a high pressure of 700 bar due to its large volume in the gaseous state, and therefore, it should have high hydrogen permeation barrier properties, strength and durability, and be light weight.

Currently, hydrogen tanks applied by domestic and foreign automotive OEMs are produced by injection molding a polyamide (PA) liner, performing laser welding, and then winding carbon fibers followed by impregnating epoxy. In such hydrogen tanks, when hydrogen is stored for a long period, hydrogen gas having a small molecular size permeates through the polyamide (PA) liner having a large molecular size, and leaks to the outsize, thereby causing loss.

In addition, there is problem of increasing cost price and weight, as the thicknesses of the liner and carbon fibers are increased to secure durability during filling and discharging and storage of hydrogen gas at a high pressure (700 bar).

### SUMMARY

The examples of the present invention are to provide a fabricating method for a hydrogen storage apparatus having a lightweight composite material with hydrogen permeation barrier properties.

In addition, the examples of the present invention are to provide a fabricating method for a hydrogen storage apparatus having a lightweight composite material and a method for integrated management of life prediction which are suitable for small-diameter a hydrogen storage apparatus applicable to mass-production electric vehicles.

Furthermore, the examples of the present invention are to provide a fabricating method for a hydrogen storage apparatus having a lightweight composite material, which can reduce manufacturing cost and weight.

According to one example of the present invention, a fabricating method for a hydrogen storage apparatus having a light weight composite material, comprising; producing a polyamide nanoclay composite material for a liner; manufacturing a liner by three-dimensional suction blow molding using the polyamide nanoclay composite material for a liner; manufacturing an assembly in which the boss and the liner are joined, through spin welding between a boss and the liner; and winding at least one of carbon fibers and glass fibers on an outer surface of the assembly is provided.

The producing a polyamide nanoclay composite material for a liner may comprise; extruding a first compound obtained by mixing polyamide and nanoclay and a second compound obtained by mixing rubber and nanoclay, respectively, to generate a first master batch and a second master batch; and extruding a third compound obtained by mixing the first master batch and the second master batch to generate the polyamide nanoclay composite material for a liner.

The polyamide may comprise at least one selected from PA6, PA11, PA12, PA610, PA612.

The nanoclay may comprise at least one selected from bentonite and montmorillonite.

The boss may be formed by insert injection molding.

According to the examples of the present invention, a fabricating method for a hydrogen storage apparatus having a light weight composite material with high hydrogen permeation barrier properties is provided.

In addition, according to the examples of the present invention, a fabricating method for a hydrogen storage apparatus having a light weight composite material suitable for small-diameter a hydrogen storage apparatus applicable to mass-production electric vehicles is provided.

Furthermore, according to the examples of the present invention, a fabricating method for a hydrogen storage apparatus having a light weight composite material which can reduce manufacturing cost and weight is provided.

### BRIEF DESCRIPTION OF THE DRAWINGS

FIG. 1 is a flowchart showing the fabricating method for a hydrogen storage apparatus having a lightweight composite material according to one example of the present invention;

FIG. 2 is a schematic diagram showing the configuration of the polyamide nanoclay composite material according to one example of the present invention;

FIG. 3 is a diagram illustrating detailed steps of generating the polyamide nanoclay composite material;

FIG. 4 is a diagram showing generating a boss;

FIG. 5 is a diagram illustrating spin welding between a boss (50) and a liner (70);

FIG. 6 is a flowchart showing a method of life prediction of a hydrogen storage apparatus having a lightweight composite material according to one example of the present invention;

FIG. 7 is a diagram showing a system for performing a method for integrated management of life prediction of a hydrogen storage apparatus having a lightweight composite material; and

FIG. 8 is a diagram showing the configuration of an individual test bed (210).

### DETAILED DESCRIPTION

Hereinafter, specific embodiments of the present invention will be described with reference to drawings. The following detailed description is provided to help a comprehensive understanding of the method, device, and/or system described in the present description. However, these are only examples, and the present invention is not limited thereto.

In describing examples, when it is judged that a detailed description of the prior art related to the present invention may unnecessarily obscure the gist of the present invention, the detailed description will be omitted. In addition, the terms described below are terms defined in consideration of functions in the examples may vary depending on the intention or practice or the like of the user or operator. Therefore, the definition should be based on the contents throughout the present entire description. The terms used in the detailed description are intended to describe the examples of the present invention only, and should not be limited. Unless used otherwise clearly, singular expressions include meanings of plural expressions. In the present description, expressions such as “comprising” or “equipped” are intended to refer to certain features, numbers, steps, operations, elements, parts or combinations thereof, and they should not be construed to exclude the presence or possibility of one or more other features, numbers, steps, operations, elements, parts of combinations thereof, other than those described.

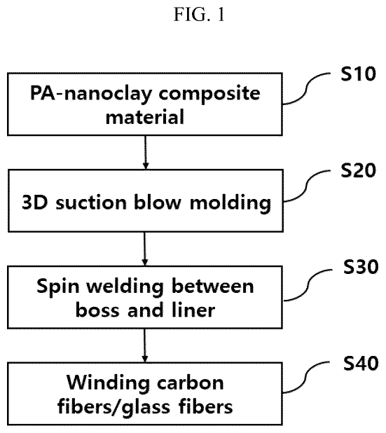

FIG. 1 is a flowchart showing the fabricating method for a hydrogen storage apparatus having a lightweight composite material according to one example of the present invention.

Referring to FIG. 1, the fabricating method for a hydrogen storage apparatus having a light weight composite material according to one example of the present invention, may include producing a polyamide nanoclay composite material for a liner (S10), manufacturing a liner by three-dimensional suction blow molding using the polyamide nanoclay composite material for a liner (S20), manufacturing an assembly in which the boss and the liner are joined, through spin welding between a boss and the liner (S30), and winding at least one of carbon fibers and glass fibers on an outer surface of the assembly (S40).

Hereinafter, these steps will be described in detail.

It is most important for a polyamide nanoclay composite material for a liner to prevent hydrogen permeation. In the case of a hydrogen storage apparatus, it must be prevented that hydrogen gas having a molecular size permeates through a liner and leak to the outside when hydrogen is stored for a long period of time. For reduction of hydrogen permeation and light weight, a liner may be manufactured by applying a composite material of polyamide and nanoclay.

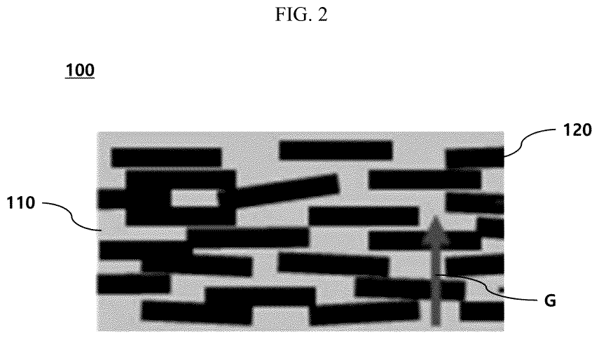

FIG. 2 is a schematic diagram showing the configuration of the polyamide nanoclay composite material according to one example of the present invention.

Referring to FIG. 2, a polyamide nanoclay composite material (100) may be formed in which nanoclay (120) is arranged in a longitudinal direction perpendicular to the permeation direction of hydrogen gas (arrow in FIG. 2) within a polymer, polyamide (110) so as to block permeation of hydrogen gas. As such, in order to arrange the nanoclay (120) within polyamide (110) in a specific form and a specific orientation, a manufacturing method suitable therefor is required.

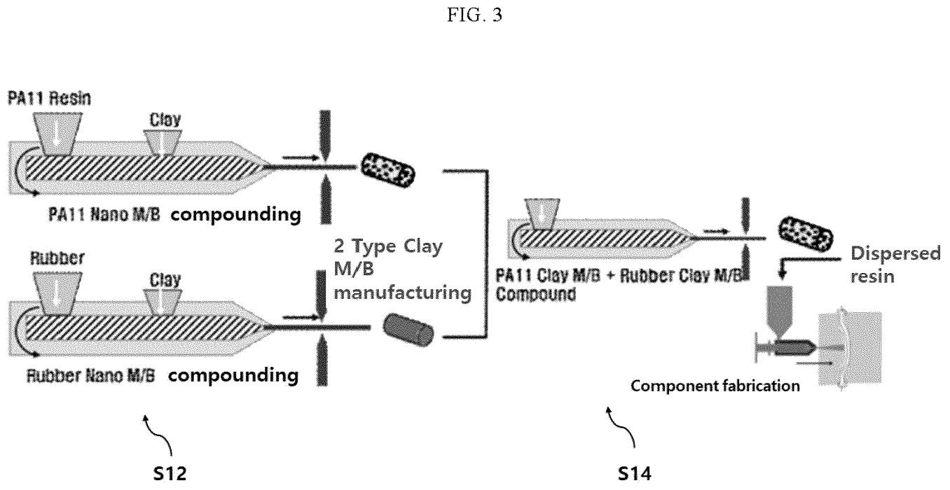

FIG. 3 is a diagram illustrating detailed steps of generating the polyamide nanoclay composite material.

Referring to FIG. 3, in order to generate a polyamide nanoclay composite material for a liner, each mater batch, that is, two type of master batches, which are a first master batch and a second master batch may be generated, by first extruding a first compound (upper portion of S12) obtained by mixing polyamide and nanoclay, and at the same time, extruding a second compound (lower portion of S12) obtained by mixing rubber and nanoclay (S12). In addition, a polyamide nanoclay composite material for a liner may be generated by extruding a third compound obtained by mixing the first master batch and the second master batch (S14). By generating the two types of master batches and conducting the two-step extrusion as such, the dispersibility within the polyamide nanoclay composite material for a liner can be improved, and the shape (one-dimensional rod shape) and orientation (specific longitudinal direction) of the nanoclay (120) in the polyamide (110) can be optimized to enhance permeation barrier properties.

Herein, the polyamide (110) may include at least one selected from PA6, PA11, PA12, PA610, PA612. In addition, the nanoclay (120) may include at least one of bentonite and montmorillonite. However, the type of the nanoclay (120) is not limited thereto, but other nanoclay may be included as long as it can improve characteristics of a liner of a hydrogen storage container.

The liner may be formed through three-dimensional suction blow molding using a polyamide nanoclay composite material for a liner formed by the method. Since no pinch off line is formed, compared with conventional injection molding and general blow processes, unnecessary portions may not be present.

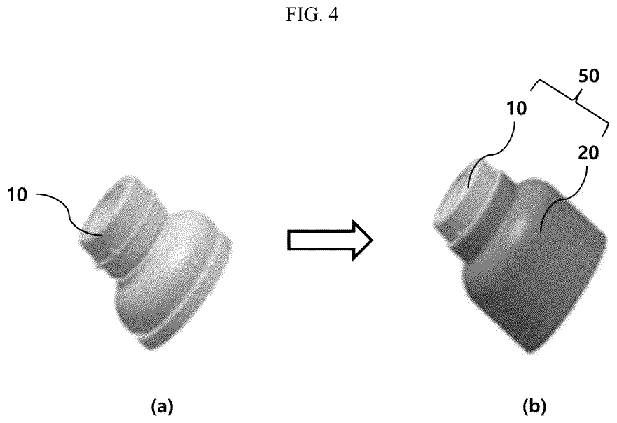

FIG. 4 is a diagram showing generating a boss.

Referring to FIG. 4, the boss (50) may be formed by performing insert injection molding on the surface of a boss base (10), in a state in which an injection-molded material (20) is joined with the boss base.

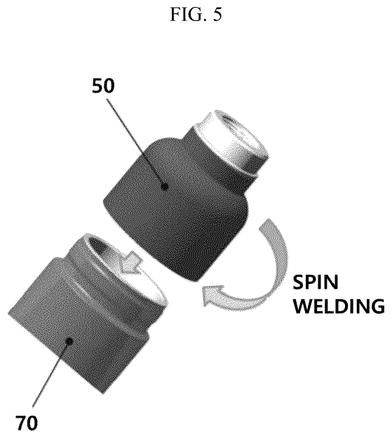

FIG. 5 is a diagram illustrating spin welding between the boss (50) and a liner (70).

Referring to FIG. 5, by performing spin welding between the boss (50) formed by the method and a liner (70) formed with a polyamide nanoclay composite material for a liner, an assembly in which the boss (50) and the liner (70) are joined may be manufactured. Spin welding may allow the boss (50) and the liner (70) to be joined with high efficiency by replacing the conventional welding method, laser welding.

In addition, a hydrogen storage apparatus having a lightweight composite material may be completed by winding at least one of carbon fibers and glass fibers on an outer surface of the assembly in which the boss and liner are jointed.

The hydrogen storage apparatus having a lightweight composite material formed in this manner can enhance hydrogen permeation barrier properties while forming a lightweight hydrogen storage apparatus. In addition, since a hydrogen storage apparatus which has a small capacity and is lightweight is required in case of hydrogen electric vehicles developed and mass-produced recently, the fabricating method for a hydrogen storage apparatus having a light weight composite material according to one example of the present invention is suitable for such hydrogen electric vehicles and can be used to electric vehicle platforms.

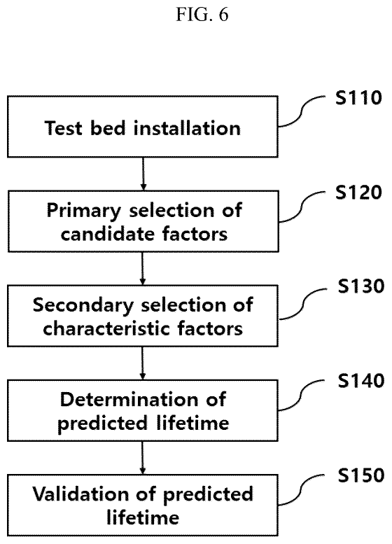

FIG. 6 is a flowchart showing a method of life prediction of a hydrogen storage apparatus having a lightweight composite material according to one example of the present invention.

Referring to FIG. 6, the method of life prediction of a hydrogen storage apparatus having a lightweight composite material may proceed according to the following steps.

First, a hydrogen storage apparatus having a lightweight composite material may be installed in a test bed which creates an environment for a hydrogen storage apparatus having a lightweight composite material (S110). The test bed will be described later. In addition, a plurality of signals generated from the hydrogen storage apparatus having a light weight composite material may be extracted and primarily selected as candidate factors (S120), and among the candidate factors, characteristic factors corresponding to degradation factors of the hydrogen storage apparatus having a light weight composite material may be secondarily selected (S130).

A degree of degradation of the hydrogen storage apparatus having a light weight composite material may be evaluated, based on the characteristic factors to determine a predicted lifetime (S140), and the predicted lifetime may be validated by learning results of measuring an actual degree of degradation of the hydrogen storage apparatus having a light weight composite material (S150).

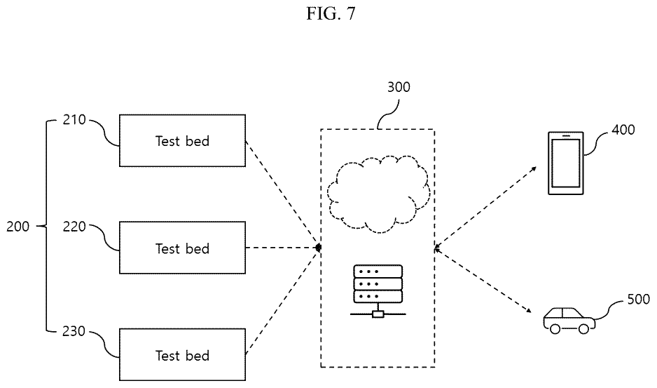

FIG. 7 is a diagram showing a system for performing a method for integrated management of life prediction of a hydrogen storage apparatus having a lightweight composite material.

Referring to FIG. 7, in order to perform the step S110, an environment in which the hydrogen storage apparatus having a light weight composite material is placed may be created in a plurality of test beds (200) in which individual test beds (210, 220, 230) are gathered, and a plurality of signals may be extracted therefrom and sent to a server (300). The server (300) may be a cloud or a server computer. In the server (300), a process of determining a predicted lifetime by performing primary selection for candidate factors and secondary selection for characteristic factors from the received signals, and evaluating a degree of degradation of the hydrogen storage apparatus having a lightweight composite material may be performed. The performed results may be sent to an individual terminal (400) to provide information on the predicted lifetime to a user who needs information related to the predicted lifetime of the hydrogen storage apparatus.

In addition, verification of the predicted lifetime determined by the server (300) may be performed, as lifetime-related data coming from the actually installed hydrogen storage apparatus having a light weight composite material as the hydrogen storage apparatus having a light weight composite material is actually installed in an automobile (500) is sent to the server (300) again.

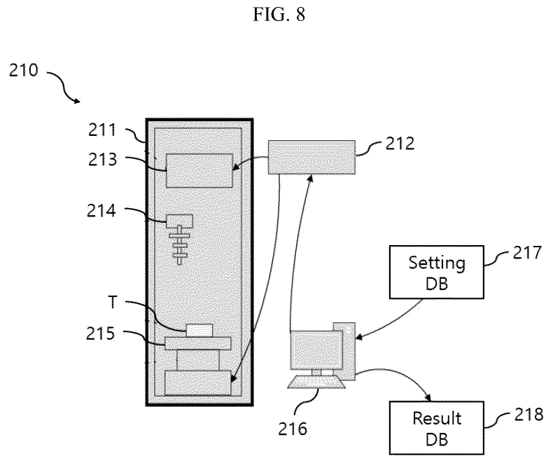

FIG. 8 is a diagram showing the configuration of an individual test bed (210).

Referring to FIG. 8, for performing a test for a hydrogen storage apparatus having a light weight composite material (T), the individual test bed (210) may include a chamber (211), a chamber control unit (212), a temperature and humidity test unit (213), an electromagnetic compatibility test unit (214), a vibration test unit (215), a test control unit (216), a test setting database (217) and a test result database (218).

The temperature and humidity test unit (213), electromagnetic compatibility test unit (214), and vibration test unit (215) may create an environment for the hydrogen storage apparatus having a lightweight composite material (T). The chamber control unit (212) may control various environmental conditions generated in the chamber (211), and the test control unit (216) may collect the environmental conditions and signals generated from the hydrogen storage apparatus having a lightweight composite material (T) with respect thereto. The test setting database (217) may store setting data for environmental conditions required for the test, and the test result database (218) may store result signals obtained from the test under each environmental condition.

Representative examples of the present invention are described in detail above, but those skilled in the art to which the present invention pertains will understand that various modifications can be made to the afore-mentioned examples within limits without departing from the scope of the present invention. Therefore, the scope of the present invention should not be limited to the examples described, and should be determined by not only claims described later but also equivalents to these claims.

What is claimed is:

1. A fabricating method for a hydrogen storage apparatus having a lightweight composite material, comprising;
producing a polyamide nanoclay composite material for a liner;
manufacturing a liner by three-dimensional suction blow molding using the polyamide nanoclay composite material for a liner;
manufacturing an assembly in which the boss and the liner are joined, through spin welding between a boss and the liner; and
winding at least one of carbon fibers and glass fibers on an outer surface of the assembly.

2. The fabricating method of claim 1, wherein the producing of the polyamide nanoclay composite material comprises:
extruding a first compound obtained by mixing polyamide and nanoclay and a second compound obtained by mixing rubber and nanoclay, respectively, to generate a first master batch and a second master batch; and
extruding a third compound obtained by mixing the first master batch and the second master batch to generate the polyamide nanoclay composite material for a liner.

3. The fabricating method of claim 2, wherein the polyamide comprises at least one selected from the group consisting of PA6, PA11, PA12, PA610, and PA612.

4. The fabricating method of claim 2, wherein the nanoclay comprises bentonite and/or montmorillonite.

5. The fabricating method of claim 2, wherein the boss is formed by insert injection molding.

6. A method for integrated management of life prediction of a hydrogen storage apparatus having a lightweight composite material, which is performed in a computing device comprising one or more processors and a memory storing one or more programs executed by the one or more processors, the method comprising:
extracting a plurality of signals generated from a hydrogen storage apparatus having a lightweight composite material installed in a test bed that creates an environment for a hydrogen storage apparatus having a lightweight composite material, and primarily selecting them as candidate factors;
secondarily selecting characteristic factors corresponding to degradation factors of the hydrogen storage apparatus having a lightweight composite material among the candidate factors;
determining a predicted lifetime by evaluating a degree of degradation of the hydrogen storage apparatus having a lightweight composite material based on the characteristic factors; and
validating the predicted lifetime by learning from results of measuring an actual degree of degradation of the hydrogen storage apparatus having a lightweight composite material.
